(19) United States
(12) Patent Application Publication
(10) Pub. No.: US 2024/0300023 A1
(43) Pub. Date: Sep. 12, 2024

(54) AM SYSTEM INCORPORATING SOLID-STATE SCANNING COMBINED WITH MOVABLE-OPTIC SCANNING

(71) Applicant: Divergent Technologies, Inc., Los Angeles, CA (US)

(72) Inventors: Michael Thomas KENWORTHY, Rancho Palos Verdes, CA (US); Gregory S. Weaver, Los Angeles, CA (US)

(21) Appl. No.: 18/597,782

(22) Filed: Mar. 6, 2024

Related U.S. Application Data
(60) Provisional application No. 63/450,327, filed on Mar. 6, 2023.

(51) Int. Cl. B22F 12/49; B22F 12/43; B22F 12/45; B22F 12/47; B22F 12/52

(52) U.S. Cl. CPC B22F 12/49; B22F 12/43; B22F 12/45; B22F 12/47; B22F 12/52

(57) ABSTRACT

An additive manufacturing method and apparatus may implement a include a laser scanner with a movable-optic scanner including one or more optics, the movable-optic scanner configured move the one or more optics to scan the laser beam along a first path, and a solid-state scanner configured to scan the laser beam along a second path. The device may include a controller configured to control the laser scanner to operate the movable-optic scanner and the solid-state scanner to combine the first path and the second path to obtain a combined path during the additive manufacturing process.

### CROSS-REFERENCE TO RELATED APPLICATION

This application claims the benefit of U.S. Provisional Application No. 63/450,327 filed on Mar. 6, 2023, titled: AM SYSTEM INCORPORATING ULTRA-FAST SCANNING SUPERIMPOSED WITH TRADITIONAL GALVANOMETER TOOLPATHING, the entirety of which is incorporated by reference herein.

### FIELD

The present disclosure relates generally to additive manufacturing, and more particularly, to controlling laser scanning in an additive manufacturing apparatus.

### BACKGROUND

Additive manufacturing (AM) systems can produce metal structures (referred to as build pieces) with geometrically complex shapes, including some shapes that are difficult or impossible to create with conventional manufacturing processes. (AM) techniques are used to create build pieces layer-by-layer, i.e., slice-by-slice. Each layer or slice can be formed by a process of depositing a layer of metal powder and fusing (e.g., adhering, and/or melting and cooling) areas of an additive material that coincide with the cross-section of the build piece in the layer. The process can be repeated to form the next slice of the build piece, and so on. Because each layer is deposited on the previous layer, AM can be likened to forming a structure slice-by-slice and allows for the formation of structures that were previously not possible to be formed by traditional machining (i.e., subtractive manufacturing) technologies.

AM systems may incorporate one or more lasers (i.e., may be laser-based). In a laser based AM system, a laser may be directed, steered or “scanned” to provide energy to an AM build material to melt or sinter the build material and ultimately form the build piece. Laser-based AM systems may be useful for reducing delays related to prototyping/tooling and/or for manufacturing complex geometries, however, manufacturing using laser-based AM systems may be slower and/or less energy efficient than desired for high-capacity production. Thus, the need exists to further improve the efficiency and/or speed of production using laser-based AM systems and methods.

### SUMMARY

The following presents a simplified summary of one or more aspects of the invention in order to provide a basic understanding of such aspects. This summary is not an extensive overview of all contemplated aspects and is intended to neither identify key or critical elements of all aspects nor delineate the scope of any or all aspects. Its purpose is to present some concepts of one or more aspects in a simplified form as a prelude to the more detailed description that is presented later.

In some aspects described herein, an additive manufacturing (AM) apparatus including a laser apparatus configured to provide a laser beam is disclosed. The apparatus may further include a laser scanner including a movable-optic scanner including one or more optics, the movable-optic scanner configured move the one or more optics to scan the laser beam along a first path. The apparatus may further include a solid-state scanner configured to scan the laser beam along a second path, and a controller configured to control the laser scanner to operate the movable-optic scanner and the solid-state scanner to combine the first path and the second path to obtain a combined path during an AM process.

Some aspects described herein include an additive manufacturing (AM) method for scanning a laser beam with a movable-optic laser scanner and a solid-state laser scanner to form an AM build. The method may further include scanning an x-position and a y-position of the laser beam with the movable-optic laser scanner while scanning at least one of a combined x-position or a combined y-position of the laser beam with the solid-state laser scanner.

In some aspects described herein, an additive manufacturing (AM) method for forming an AM build is disclosed. The method may include applying a layer of powder material in a build area, leveling the layer of powder, and applying laser beam to at least one portion of the leveled layer of power by controlling a path of the laser beam with a first scanning device and a second scanning device, wherein the second scanning device is a solid-state device.

Other aspects will become readily apparent to those skilled in the art from the following detailed description, wherein is shown and described only several example implementations by way of illustration. As will be realized by those skilled in the art, concepts described herein are capable of other and different embodiments, and several details are capable of modification in various other respects, all without departing from the present disclosure. Accordingly, the drawings and detailed description are to be regarded as illustrative in nature and not as restrictive.

### BRIEF DESCRIPTION OF THE DRAWINGS

Various characteristic and aspects of the technology described herein are set forth as follows, in the appended claims, and in the drawings. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use, further objects and advances thereof, will be best understood by reference to the following detailed description of illustrative aspects when read in conjunction with the accompanying drawings.

FIGS. 1A-1D illustrate respective side views of an example Powder Bed Fusion (PBF) system usable with aspects of the disclosure during different stages of operation according to aspects of the disclosure.

FIG. 2 illustrates an example of a wire Directed Energy Deposition (DED) system usable with aspects of the disclosure.

FIGS. 3A-3B illustrate example diagram views of a laser and optical components and apparatuses according to aspects of the disclosure.

FIG. 4 is a front view of an example Additive Manufacturing (AM) system according to aspects of the disclosure.

FIGS. 5A-5H show examples of potential first scanning paths, second scanning paths, and combined scanning paths according to aspects of the disclosure.

FIG. 6A illustrates an example of melt pools formed by a laser according to aspects of the disclosure.

FIG. 6B illustrates an example of a traveling melt pool formed by a laser according to aspects of the disclosure.

FIG. 7 illustrates an example of a skywriting laser path according to aspects of the disclosure.

FIG. 8 illustrates an example of a skywriting laser path and combined path according to aspects of the disclosure.

FIG. 9 illustrates an example of a curved laser path and combined path according to aspects of the disclosure.

FIG. 10 illustrates an example representative diagram of various components of an example controller usable with aspects of the disclosure.

FIG. 11 illustrates an example of a computer system in accordance with aspects of the disclosure.

FIG. 12 illustrates an example of various system components in accordance with aspects of the present disclosure.

### DETAILED DESCRIPTION

The detailed description set forth below in connection with the appended drawings is intended to provide a description of various exemplary embodiments of the concepts disclosed herein and is not intended to represent the only embodiments in which the disclosure may be practiced. The term “exemplary” used in this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the concepts to those skilled in the art. However, the disclosure may be practiced without these specific details. In some instances, well-known structures and components may be shown in block diagram form, or omitted entirely, in order to avoid obscuring the various concepts presented throughout this disclosure.

### I. Terminology

Reference throughout this specification to one aspect, an aspect, one example or an example means that a particular feature, structure or characteristic described in connection with the embodiment or example may be a feature included in at least example of the present invention. Thus, appearances of the phrases in one aspect, in an aspect, one example or an example in various places throughout this specification are not necessarily all referring to the same example. Furthermore, the particular features, structures or characteristics may be combined in any suitable combinations and/or subcombinations in one or more embodiments or examples.

Throughout the disclosure, the terms substantially or approximately may be used as a modifier for a geometric relationship between elements or for the shape of an element or component. While the terms substantially or approximately are not limited to a specific variation and may cover any variation that is understood by one of ordinary skill in the art to be an acceptable level of variation, some examples are provided as follows. In one example, the term substantially or approximately may include a variation of less than 10% of the dimension of the object or component. In another example, the term substantially or approximately may include a variation of less than 5% of the object or component. If the term substantially or approximately is used to define the angular relationship of one element to another element, one non-limiting example of the term substantially or approximately may include a variation of 5 degrees or less. These examples are not intended to be limiting and may be increased or decreased based on the understanding of acceptable limits to one of skill in the relevant art.

For purposes of the disclosure, directional terms are expressed generally with relation to a standard frame of reference when the aspects or articles described herein are in an in-use orientation. In some examples, the directional terms are expressed generally with relation to a left-hand coordinate system.

Terms such as a, an, and the, are not intended to refer to only a singular entity, but also include the general class of which a specific example may be used for illustration. The terms a, an, and the, may be used interchangeably with the term at least one. The phrases at least one of and comprises at least one of followed by a list refers to any one of the items in the list and any combination of two or more items in the list. All numerical ranges are inclusive of their endpoints and non-integer values between the endpoints unless otherwise stated.

The terms first, second, third, and fourth, among other numeric values, may be used in this disclosure. It will be understood that, unless otherwise noted, those terms are used in their relative sense only. In particular, certain components may be present in interchangeable and/or identical multiples (e.g., pairs). For these components, the designation of first, second, third, and/or fourth may be applied to the components merely as a matter of convenience in the description.

The term powder bed fusion (PBF) is used throughout the disclosure. PBF systems may encompass a wide variety of additive manufacturing (AM) techniques, systems, and methods. Thus, the PBF system or process as referenced in the disclosure may include, among others, the following printing techniques: direct metal laser sintering (DMLS), electron beam melting (EBM), selective heat sintering (SHS), selective laser melting (SLM) and selective laser sintering (SLS). PBF fusing techniques may further include, for example, solid state sintering, liquid phase sintering, partial melting, full melting, chemical binding and other binding and sintering technologies. Still other PBF processes to which the principles of this disclosure are pertinent include those that are currently contemplated or under commercial development. The aspects of the disclosure may additionally be relevant to non-metal additive manufacturing.

### II. Detailed Examples

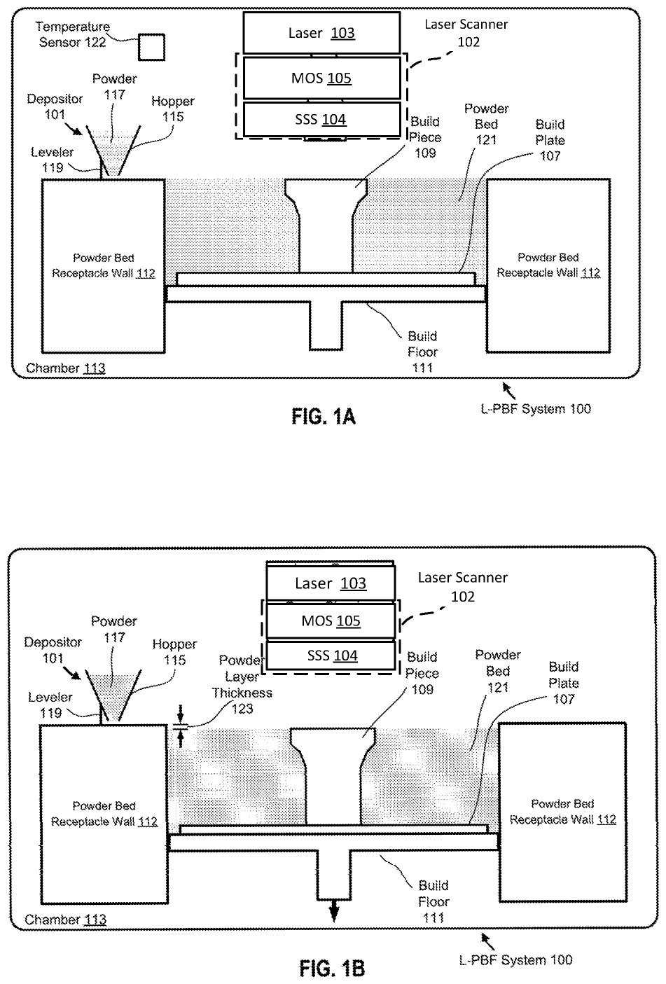

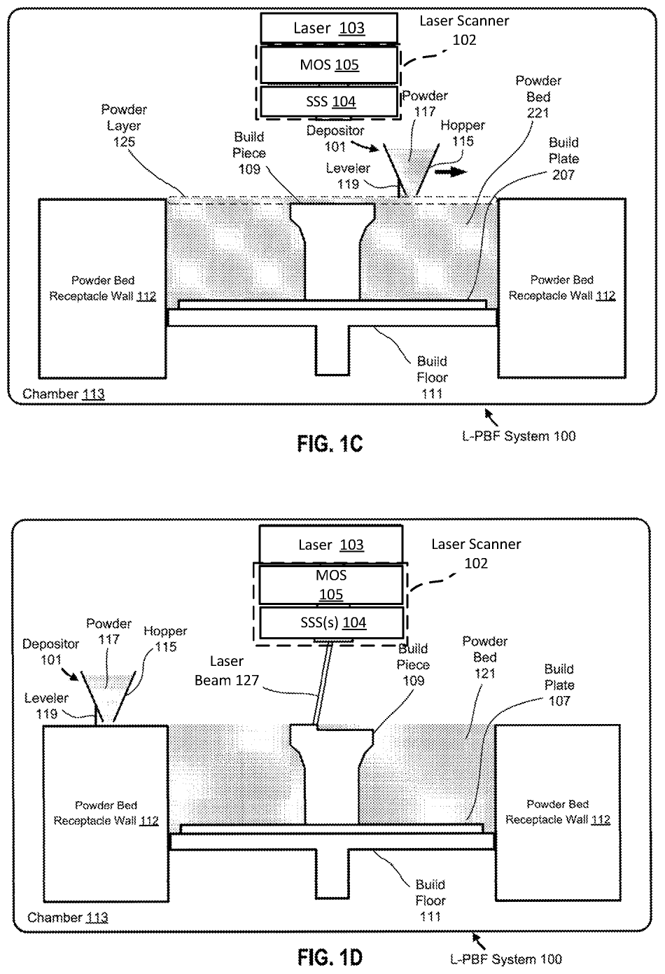

Additive manufacturing (AM) systems, such as powder bed fusion (PBF) systems, can produce structures (referred to as build pieces) with geometrically complex shapes, including some shapes that are difficult or impossible to create with conventional manufacturing processes. PBF systems create build pieces layer-by-layer, i.e., slice-by-slice. Each slice can be formed by a process of depositing a layer of powder (e.g., metal or metallic powder) and fusing (e.g., melting and cooling) areas of the metal powder layer that coincide with the cross-section of the build piece in the slice. The process can be repeated to form the next slice of the build piece, and so on. FIGS. 1A-D illustrate respective side views of an example of a PBF system 100 usable with aspects of the disclosure during different stages of operation. As noted above, the particular embodiment illustrated in FIGS. 1A-D is one of many suitable examples of a PBF system employing principles of this disclosure. It should also be noted that elements of FIGS. 1A-D and the other figures in this disclosure are simplified and not necessarily drawn to scale, but may be drawn larger or smaller and/or with reduced detail for the purpose of better illustration of concepts described herein. PBF system 100 can include a depositor 101 that can deposit each layer of metal powder, a laser 103 that can generate a laser beam, a laser scanner 102 that can direct or redirect the laser beam along a path to fuse the powder material, and a build plate 107 that can support one or more build pieces, such as a build piece 109. Laser scanner 102 can include a solid-state scanner (SSS) 104 and a movable-optic scanner (MOS) 105. MOS 105 can include one or more optics (e.g., mirrors and/or lenses) that the MOS can physically move (e.g., rotate, tilt, translate, etc.) to scan the laser beam along a first path. MOS 105 can include, for example, motorized mirror/lens scanner, galvanometer (galvo) scanner, gimbal-mirror scanners, etc. SSS 104 can scan the laser beam along a second path. SSS 104 can include, for example, an acousto-optic device, an electro-optic device, etc. The first and second paths can be combined to form a combined path, described in more detail below. In the embodiment shown in FIGS. 1A-D, MOS 105 is applied to the laser beam before SSS 104 is applied. However, in various embodiments, the SSS can be applied to the laser beam before the MOS.

PBF system 100 can also include a build floor 111 positioned within a powder bed receptacle. The walls of the powder bed receptacle 112. Build floor 111 can progressively lower build plate 107 so that depositor 101 can deposit a next layer. In some examples, the entire mechanism may reside in a chamber 113 that can enclose the other components, thereby protecting the equipment, enabling atmospheric (e.g., providing an inert environment) and temperature regulation and mitigating contamination risks. Depositor 101 can include a hopper 115 that contains a powder 117, such as a metal powder, and a leveler 119 that can level the top of each layer of deposited powder.

Referring specifically to FIG. 1A, this figure shows PBF system 100 after a slice of build piece 109 has been fused, but before the next layer of powder has been deposited. In fact, FIG. 1A illustrates a time at which PBF system 100 has already deposited and fused a partially completed build piece in multiple layers to form the current state of build piece 109. The multiple layers already deposited have created a powder bed 121, which includes powder that was deposited but not fused.

FIG. 1B shows PBF system 100 at a stage in which build floor 111 can lower by a powder layer thickness 123. The lowering of build floor 111 causes build piece 109 and powder bed 121 to drop by powder layer thickness 123, so that the top of the build piece and powder bed are lower than the top of powder bed receptacle wall 112 by an amount equal to the powder layer thickness. In this way, for example, a space with a consistent thickness equal to powder layer thickness 123 can be created over the tops of build piece 109 and powder bed 121.

FIG. 1C shows PBF system 100 at a stage in which depositor 101 is positioned to deposit powder 117 in a space created over the top surfaces of build piece 109 and powder bed 121 and bounded by powder bed receptacle walls 112. In this example, depositor 101 moves over the defined space while releasing powder 117 from hopper 115. Leveler 119 can level the released powder to form a powder layer 125 that has a thickness substantially equal to the powder layer thickness 123 (see FIG. 1B). Thus, the powder in a PBF system can be supported by a powder material support structure, which can include, for example, a build plate 107, a build floor 111, a build piece 109, walls 112, and the like. It should be noted that the illustrated thickness of powder layer 125 (i.e., powder layer thickness 123 (FIG. 1B)) is greater than an actual thickness used for the example involving 150 previously-deposited layers discussed above with reference to FIG. 1A.

FIG. 1D shows PBF system 100 at a stage in which, following the deposition of powder layer 125 (FIG. 1C), laser 103 generates a laser beam 127 and laser scanner 102, directs, and/or redirects the energy beam along a path on the surface of the powder layer 125 to melt, sinter, and/or melt the next slice in build piece 109. The laser scanner 102 may include MOS 105, which uses one or more motors, galvos, gimbals, etc., controlling one or more mirrors and/or lenses for reflection and/or refraction to manipulate the laser beam to scan selected areas of the powder layer 125 to be fused. In various aspects of the disclosure, MOS 105 can include one or more gimbals and actuators, which may be motor-controlled, that can rotate and/or translate the energy beam source to position the energy beam. In various embodiments, laser 103 and/or laser scanner 102 can modulate the energy beam, e.g., turn the energy beam on and off and/or control the divergence of the laser 103 as the laser scanner 102 scans so that the energy beam is applied only in the appropriate areas of the powder layer(s) and/or to control the energy applied to the powder layer(s). For example, in various aspects of the disclosure, the laser beam can be modulated by a digital signal processor (DSP). The MOS may include any known system in the art, for example a galvo-scanner or galvanometer, and/or a raster scanner. It is noted that while a single laser 103 and laser scanner 102 are shown, aspects of the disclosure are usable with and may include a system with multiple lasers and/or laser scanners. In one aspect disclosed herein, the laser scanner 102 may include one or more solid-state scanners (“SSC”) 104, described in detail below.

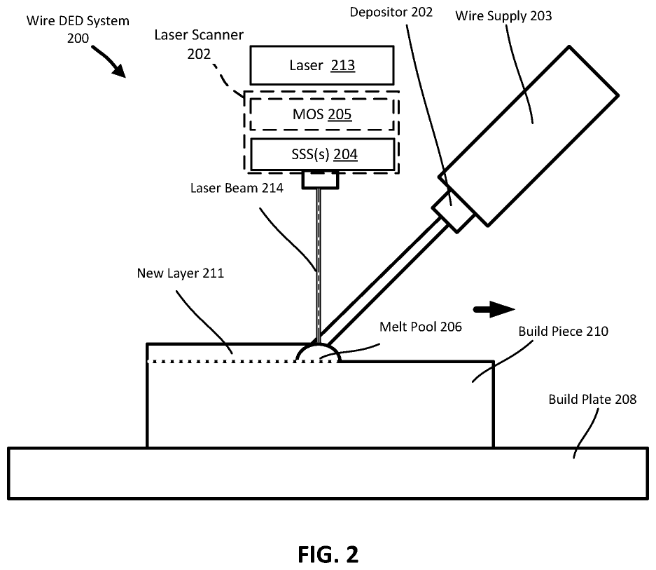

FIG. 2 illustrates an example wire Directed Energy Deposition (“DED”) system 200 for AM using wire or extrusions. A wire DED system 200 can include a depositor 202 that can deposit each layer of wire or extruded material from a supply apparatus 203, a laser 213 or other energy source can generate heat to melt each layer of material upon deposition and form a melt pool 206, and a build plate 208 that can support one or more build pieces, such as build piece 210. The example of FIG. 2 shows wire DED system 200 after multiple layers of build piece 210 have each been deposited, and while a new layer 211 is being deposited. While depositing the new layer, build piece 210 can remain stationary, and depositor 202 and laser 204 can cross a length and width of the build piece while releasing wire and generating heat, respectively. Alternatively, or in combination with movement of the laser 203, the build piece 210 can move under the depositor and laser 203. The laser 204 may generate a laser beam 114, which may pass through or otherwise be affected by laser scanner 202 that uses reflection and/or refraction to manipulate the laser beam to scan selected areas to be fused.

In various aspects of the disclosure, the laser scanner 202 may include an SSS 204 and, optionally, a MOS 205. SSS 204 can include, for example, an acousto-optic device, an electro-optic device, etc. Optional MOS 205 can include one or more gimbals and actuators that can rotate and/or translate the laser source to position the energy beam. By controlling the laser scanner 202, the laser beam 214 can be scanned in the x-direction and/or y-direction to allow for scanning of the laser over the wire or an extrusion from the depositor 202. In various aspects, laser 213 and/or laser scanner 202 can modulate the energy beam, e.g., turn the energy beam on and off as the deflector scans so that the energy beam is applied only in the appropriate areas of the wire or extrusion provided by the depositor. For example, in various aspects of the disclosure, the energy beam can be modulated by a digital signal processor (DSP). It is noted that while a single laser 213 and laser scanner 202 are shown, aspects of the disclosure are usable with and may include a system with multiple energy source(s) and/or deflector(s). In one aspect disclosed herein, the laser scanner 202 may include one or more solid-state scanners (“SSS”) 204, described in detail below.

While conventional laser scanners may typically be effective at controlling scanning of the lasers, aspects of this disclosure further improve, e.g., the speed, efficiency, versatility, etc. of scanning. As shown in FIGS. 1A-1D and 2, one or more solid-state scanners 104 and/or 204 may be implemented to further control scanning of the laser. As noted above, the aforementioned movable-optic scanner 105 and/or 205 may scan a laser beam by moving one or more optics (e.g., mirrors, lenses) with, for example, motors, galvos, gimbals, etc., and thus the scanning of the laser and particularly the speed and accuracy of direction changes may be limited due to the physical limitations of an MOS system. For example, optics have mass. When mirrors and lenses are moved, the movement of their mass creates inertia in the direction of motion. Changing the motion (i.e., changing the path of the laser beam) requires force to overcome the inertia of the moving optics. The motors, galvos, gimbals, etc. can impart a limited force to change the direction of motion of the optics, and thus there are limits to how quickly and how often an MOS can change the direction of a laser beam. For example, when the desired path of the laser beam includes a sharp angle, e.g., a right angle, an MOS may not be able to change direction (e.g., overcome the inertia of the optics) quick enough to make the right angle turn properly. As a result, many laser scanners must implement “skywriting,” described in more detail below, which requires the laser beam to be turned off for a period of time during the scan. This creates an inefficiency that can result in significant lost up-time for the laser scanning. Another limitation of MOS systems can be, for example, if operated at high speeds for a long period of time, the MOS may begin to generate excess heat, which may require slowing of the scanning of the laser or may even result in scanning defects.

For example, if the MOS includes a galvanometer, the MOS may operate on a kilohertz (kHz) scale. Solid-state devices, on the other hand, may not require motors or mechanical actuators and thus can operate at higher frequencies for longer periods that is typically feasible for a galvanometer or other movable-optic deflector or scanner. A solid-state scanner (SSS) may operate on a megahertz (MHz) scale.

In one example implementation of the disclosure, an SSS or multiple SSSs (e.g., a first solid-state scanner to control the x-direction of the laser and a second solid-state scanner to control the y-direction of the laser) can be implemented into an AM system to provide higher-speed scanning and/or quicker and/or more accurate directional changes and/or complex scan patterns that are not typically feasible with a movable-optic scanner. However, some solid-state scanners may have limitations as to amount of deflection or distance in the x-direction or y-direction that a laser may be deflected or scanned by the solid-state scanner. In other words, movable-optic scanners may only be capable of slower scanning speeds while allowing for scanning of the laser over larger distances in the x-direction and/or y-direction (e.g., over the entire layer of powder 125 in FIG. 1C or the entire build piece 210 and/or build plate 208 in FIG. 2), while solid-state scanners may be capable of higher scanning speeds, while only being able to scan over smaller distances in the x-direction and/or y-direction than the aforementioned movable-optic scanners. Combining a movable-optic scanners with one or more solid-state scanners allows for simultaneous scanning (e.g., combined scanning) providing any one or combination of increased speed, efficiency, control, and/or complex scanning patterns of the AM process.

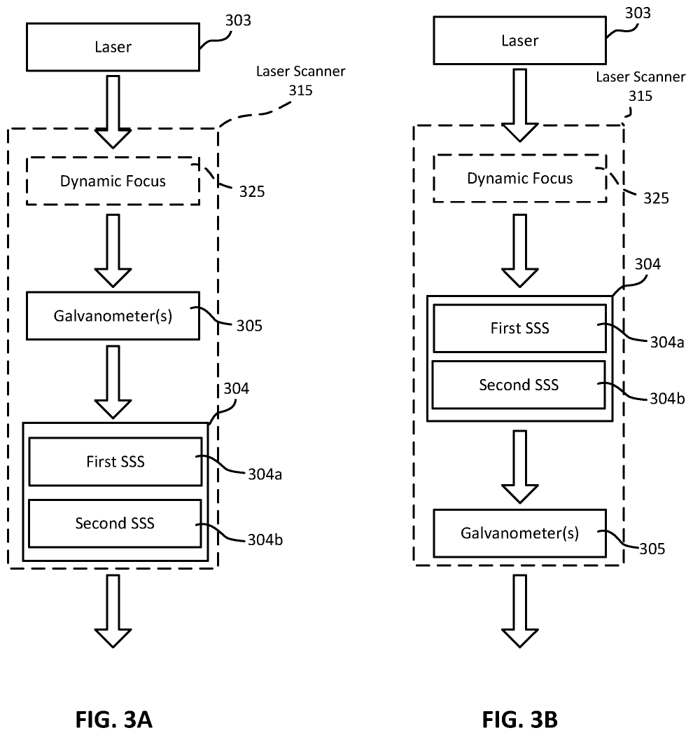

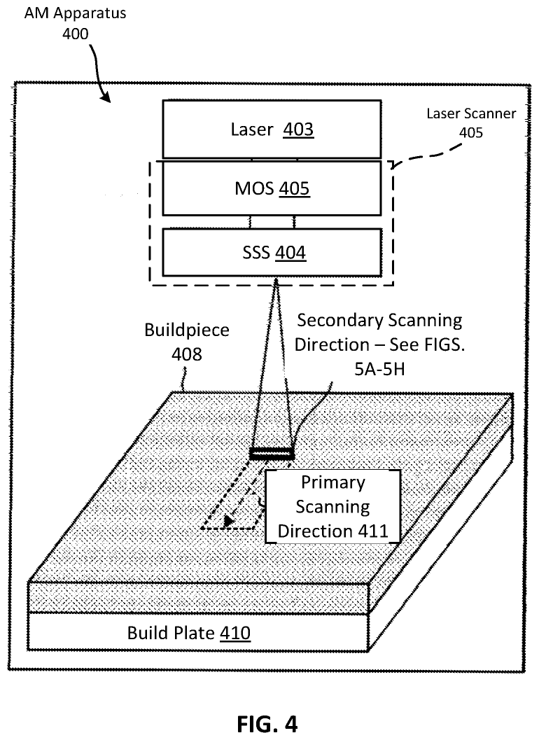

An SSS (e.g., SSS 103 in FIGS. 1A-1D, 204 in FIG. 2, 304a-304b in FIGS. 3A and 3B and/or 404 in FIG. 4) according to aspects of the disclosure may for example be comprised of piezoelectric transducer connected to or otherwise configured to move or change the geometry of a mirror, lens, or combinations thereof. In various embodiments, an SSS can be an acousto-optic device that can deflect, reflect, etc., a laser beam. In one example configuration, a piezoelectric transducer connected to or otherwise configured to control an acousto-optic medium, which may for example include any one or combination of a suitable transparent crystal(s) or glass(es) and/or mirror(s). In one example, the transducer can be driven by an electrical signal to vibrate at a certain frequency, and thus creates sound waves in the acousto-optic medium. The expansion and compression of the acousto-optic medium due to the sound waves modulate the local index of refraction and thus create a grating structure within the medium, with a period determined by the frequency of the drive signal. The aforementioned grating diffracts an incident laser as it passes through the acousto-optic medium. Acousto-optic deflectors, for example can use the diffraction of the incident laser to steer the angle of the output laser beam. The angle of deflection of the output beam depends on the period of the grating structure in the acousto-optic material and may thus be adjusted by appropriately varying the drive signal frequency. Acousto-optic deflectors may be driven with a multi-frequency drive signal in order to diffract the incident beam at different angles.

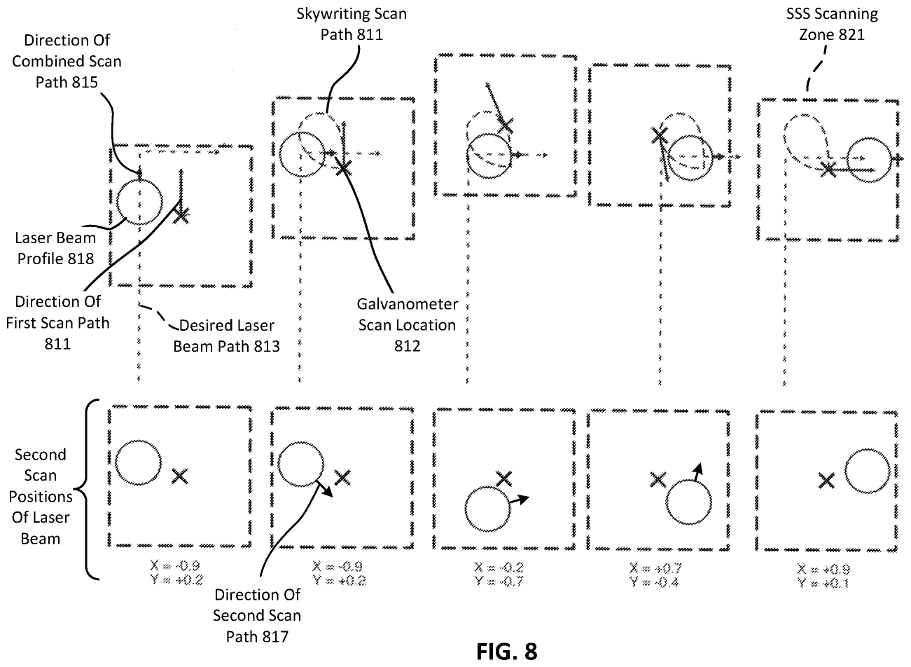

In the aforementioned example implementation, the SSS (e.g., 104 in FIGS. 1A-1D, 204 in FIG. 2, 304a-304b in FIGS. 3A and 3B and/or 404 in FIG. 4) can receive one or more laser beams either from the laser (e.g., 103 in FIGS. 1A-ID and/or 213 in FIG. 2, 303 in FIGS. 3A-3B and/or 403 in FIG. 4) or the MOS (e.g., 105 in FIGS. 1A-1D, 205 in FIG. 2, 305 in FIGS. 8, and/or 405 in FIG. 4). The input laser beam may be incident on an acousto-optic deflector. A drive circuit (also referred to simply as a “driver”) applies a multi-frequency drive signal to one or more piezoelectric transducers in order to generate acoustic waves in the acousto-optic medium. The deflector may comprise any suitable acousto-optic medium that is known in the art, including crystalline materials such as quartz, tellurium dioxide (TeO2), germanium, or glass materials such as fused silica or chalcogenide glasses. Crystalline media may be cut along specific, preferred crystal directions to obtain the desired acousto-optic properties, in terms of sound velocity and birefringence, for example. Transducers may similarly comprise one or more pieces of any suitable piezoelectric material, such as lithium niobate, which may be attached to or otherwise connected to the acousto-optic medium via a metal bonding layer.

While an acousto-optic deflector is described as an example above, any known piezoelectric or other solid-state diffraction and/or reflection device can be used without departing from the scope of this disclosure. Some additional examples include known variations of acousto-optic devices and/or known electro-optic devices.

As noted above, while the examples shown in FIGS. 1A-1D and 2 show the SSS input laser beam(s) from the MOS (e.g., galvanometer), the input laser beam(s) may instead be from the laser(s) with the output of the one or more SSS(s) as the input laser beam into the MOS, i.e., the order of the SSS(s) (e.g., 104 in FIGS. 1A-1D, 204 in FIGS. 2 and 304 in FIG. 3 may be flipped or reversed. For example, as shown in FIGS. 3A-3B, the SSS 304, which may be analogous with the SSS(s) 104 in FIGS. 1A-1D and SSS(s) 204 in FIG. 2 may either be after the galvanometer(s) 305 (i.e., as shown in FIG. 3A) or between the laser 303 and the galvanometer 305 (i.e., as shown in FIG. 3B). Further, as shown in FIGS. 3A and 3B, any one of the SSSs described herein may include multiple SSSs, such as a first SSS 304a and a second SSS 304b. In some examples, the first SSS may for example be configured to translate or steer the laser beam from laser 303 in an x-direction. Further, the second SSS 304b may be configured to translate or steer the laser beam from laser 303 in a y-direction. Further, while two SSSs are shown, in one aspect, the AM system may include only a single SSS configured to translate or steer the laser in in x-direction or may include only a single SSS configured to translate or steer the laser in a y-direction. Further, the AM system may include additional SSSs not shown. For example, the SSS may include a third SSS or fourth SSS with an output axis tilted with respect to the x-axis or y-axis of a build.

As shown in FIGS. 3A and 3B, the AM system may further include a dynamic focus apparatus 325 for focusing or de-focusing the laser beam output from laser 303. While not shown in FIGS. 1A-2, the powder bed fusion AM system 100 and/or the DED system 200 of FIG. 2 may include the dynamic focus apparatus 325 in FIGS. 3A and 3B. As shown in FIGS. 3A and 3B, any one or combination of the aforementioned systems (e.g., one or more dynamic focus apparatus(s) 325, deflector(s) (e.g., galvanometer(s) 305, the first SSS 304a and/or the second SSS 304b) may be part of an optics module or system 303 which can control the location, speed, size, and/or intensity of the laser beam (e.g., laser beam 127 in FIGS. 1A-1D and/or laser beam 214 in FIG. 2) during formation of a buildpiece using the AM apparatus.

Controlling the optical and/or laser output parameters of an AM system can directly affect the structural qualities of the build piece. One such parameter that is typically controlled during the build is volumetric energy density (VED). Generally, when forming a build piece, the goal is to improve the structural properties of the build piece and/or to control the microstructure of the build piece.

The VED may be a parameter of any one or combination of the laser(s) (e.g., 103 FIGS. 1A-1D, 213 in FIG. 2, 303 in FIGS. 3A-3B and/or 403 in FIG. 4), the MOS (e.g., 105 in FIGS. 1A-1D, 205 in FIG. 2, 305 in FIGS. 3A-3B and/or 405 in FIG. 4), solid state scanner(s) (e.g., 104 in FIGS. 1A-1D, 204 in FIG. 2, 304a-304b in FIGS. 3 and/or 404 in FIG. 4), and/or the thickness of the powder layer provided by the depositor 101 (FIGS. 1A-1D) or the thickness of the extrusion or wire provided by depositor 202 (FIG. 2). In one example, VED in joules/millimeters³ (J/mm³) is defined by equation G below, wherein E is a power of an energy source used to fuse the powdered build material, S is a scan speed of the energy source, L is a thickness of unfused build material, and H is a hatch spacing of the energy source used to fuse the powdered build material.

$$V E D = \frac{E}{S \times L \times H} \qquad ( G )$$

Further, the laser path of the laser beam may be adapted based on any one or combination of the geometry of a desired part to be built and/or based on considerations such as heat management, desired microstructure, support needs or internal stresses during a build process, to name a few non-limiting examples.

FIG. 4 shows an example of an AM apparatus 400. The AM apparatus 400 may share features with or may be analogous with the laser powder bed fusion system of FIGS. 1A-1D, the directed energy deposition system 200 of FIG. 2 and/or the optical components shown in FIGS. 3A and 3B. A laser scanner 402 can include an SSS 404 and an MOS 405.

Referring to FIG. 4, the MOS 405 may be controlled to follow a first path to scan a build material (e.g., unfused powder or extrusion to form build piece 408), which may be generally along a primary scanning direction 411. The SSS 404 may simultaneously be controlled to follow a second path to scan the material, which may be generally along a secondary scanning direction in a direction or directions different from and/or at a different speed than the deflector(s) 405. As shown in the example embodiment of FIG. 4, the secondary scanning direction can be roughly perpendicular to the primary scanning direction in various embodiments. Laser scanner 402 can combine the first path of MOS 405 with the second path of SSS 404 to form a combined path of the laser beam, examples of which are provided in more detail below.

In various embodiments, the first path and/or the second path may be continuously modified (e.g., under the control of the laser scanner) based on the geometrical boundaries of the part to be built (e.g., build piece 408).

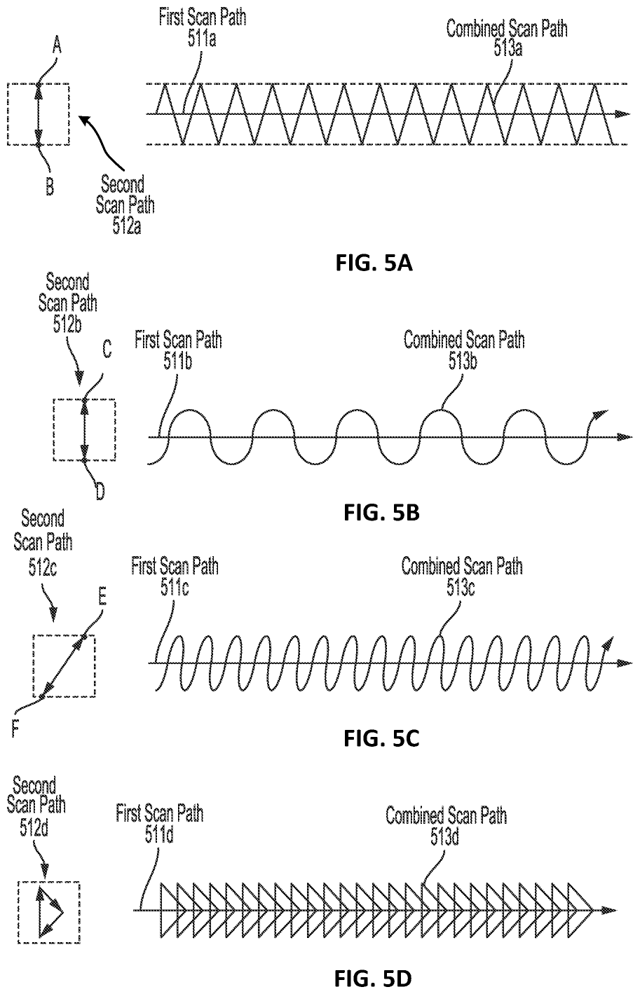

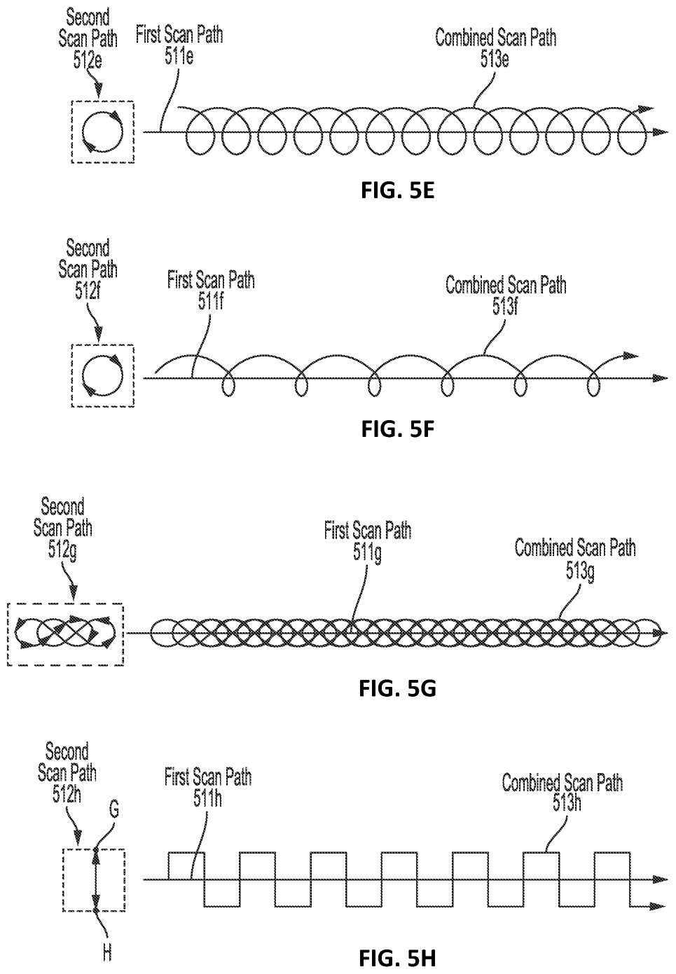

FIGS. 5A-5H show examples of combined scanning paths according to various example embodiments. In these examples, it is understood the path of the laser beam is the combined scanning path. However, for the purposes of illustration, the combined path is shown superimposed on the first scan path, and the second path is illustrated in a separate box on the left side. This is to show how the path of the laser beam (i.e., the combined path) can be viewed as generally “following” the first path (also referred to as the primary scanning direction, above) imposed by the typically “slower” MOS, while the second path imposed by the typically “faster” SSS can be viewed as creating complex, fast patterns (paths) “around” the first path in various embodiments. This is to illustrate that the addition of an SSS may allow a typically straight MOS laser path to be modified into various complex combined paths that may provide heretofore unachievable benefits, such as “widening” the scan path, in-situ “stirring” the melted AM material, additional control over the energy distribution, such as pre-heating and/or post-cooling the AM material, etc.

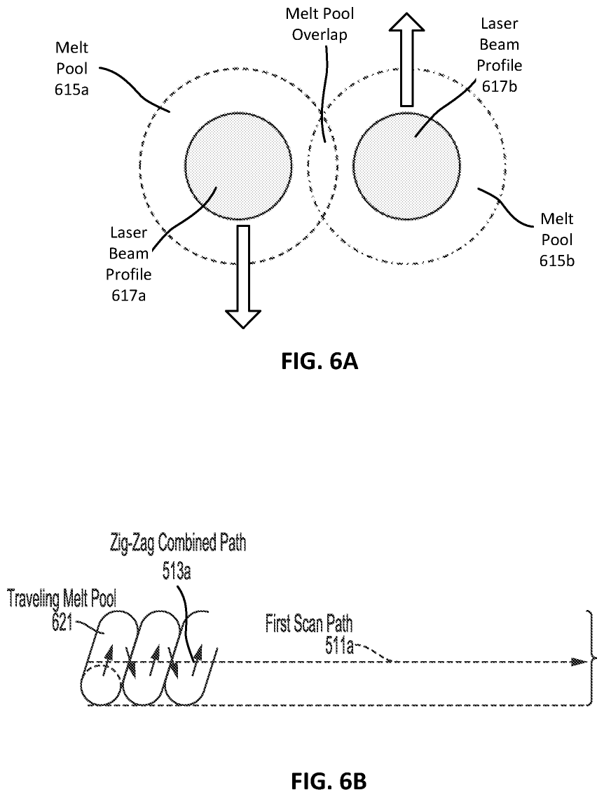

For example, FIG. 5A shows one example of a first scan path 511a (i.e., the path of the MOS), a second scan path 512a (i.e., the path of the SSS), and a combined path 513a, which is the combination of the first path and the second path. Combined path 513a is the path the laser beam will follow during an AM process, such as formation of a buildpiece, support structure, etc. As shown in the example of FIG. 5A, the first scan path 511a may be substantially linear, whereas the combined scan path 513a, which may ultimately create the melt pool or otherwise melts or sinters the previously unfused AM material may follow a zig-zag or angled path with respect to the first scan path 511a. The zig-zag combined path can be created by the second path 512a travelling up and down between point A and B, as seen in the figure. In particular, second path 512a can have a constant speed when traveling between points A and B, and sharply reverse direction at points A and B. The zig-zagging combined path 513a may be used, for example to emulate a wider melt pool than possible using an MOS alone, as illustrated below in the example of FIG. 6B.

FIG. 5B shows another example of a first scan path 511b, a second scan path 512b, and a combined scan path 513b. As shown in the example of FIG. 5B, the first scan path 511b may be substantially linear, whereas the combined scan path 513b, which may ultimately create the melt pool or otherwise melts or sinters the previously unfused AM material, may have a wide sinusoidal-shaped path with respect to the first scan path 511b. The wide sinusoidal-shaped combined path can be created by the second path 512b travelling up and down between point C and D, as seen in the figure. In particular, second path 512b can have a variable speed when traveling between points C and D, i.e., travelling faster in the middle between points C and D and slowing down when approaching points C and D to change direction. The wide sinusoidal-shaped path may be used, for example, to fuse a wide sinusoidal-shaped portion of a build piece, which may be stitched together with a corresponding wide sinusoidal-shaped portion of the build piece created by an adjacent application of second wide sinusoidal shaped path of the laser beam. In various embodiments, such interlocked or otherwise overlapped paths of melt pools may increase the strength and/or stability of the buildpiece.

FIG. 5C shows another example of a first scan path 511c, a second scan path 512c, and a combined scan path 513c. As shown in the example of FIG. 5C, the first scan path 511c may be substantially linear, whereas the combined scan path 513c, which may ultimately create the melt pool or otherwise melts or sinters the previously unfused AM material, may have an tight alternating forward-rearward path with respect to the first scan path 511c. In another aspect, the laser beam may be turned-off at the beginnings and ends of the second scan path 512c, forming a hatched pattern. The tight alternating forward-rearward combined path can be created by the second path 512c travelling in an angled up and down motion between point E and F, as seen in the figure. In particular, second path 512c can have a variable speed when traveling between points E and F, i.e., travelling faster in the middle between points E and F and making a quick but smooth turnaround at points C and D. The tight alternating forward-rearward path may be used, for example, to emulate a wider melt pool than possible using an MOS alone while distributing the laser application in a different manner than the example combined path shown in FIG. 5A.

FIG. 5D shows another example of a first scan path 511d, a second scan path 512d, and a combined scan path 513d. As shown in the example of FIG. 5D, the first scan path 511d may be substantially linear, whereas the combined scan path 513d, which may ultimately create the melt pool or otherwise melts or sinters the previously unfused AM material may have an overlapping triangular shaped path with respect to the first scan path 511d. The overlapping triangular shaped combined path can be created by the second path 512d travelling in a triangle-shaped loop, as seen in the figure. The overlapping triangular shaped path may be used, for example, to stir (e.g., stir-weld) the melted AM material in a discontinuous motion as the laser path quickly loops in a triangular motion throughout the path. The stirring may help prevent or reduce the formation of undesirable microstructures that may otherwise form in the AM material as it cools and hardens.

FIGS. 5E and 5F show other examples of first scan paths 511e and 511f, second scan paths 512e and 512f, and combined scan paths 513e and 513f. As shown in the examples of FIGS. 5E and 5F, the first scan paths 511e and 511f may be substantially linear, whereas the combined scan paths 513e and 513f, which may ultimately create the melt pool or otherwise melts or sinters the previously unfused AM material may have looped paths with respect to the first scan paths 511e and 511f, which may have a stirring (e.g., stir-welding) effect as the AM material solidifies. The looping combined paths can be created by the second paths 512e and 512f travelling in a circular loop, as seen in the figures. In these examples, the shapes of the circular loops may be the same, but the speed travel around the circular loops can be different. For example, the speed around the circular second path 512e may be faster than the speed around the circular second path 512f. As a result, combined path 513e can be a faster-repeating (i.e., “tighter”) looped path than combined path 513f. Each of the example combined paths 513e and 513f may be used to stir (e.g., weld stir) the melted AM material to various degrees according to, for example, the laser power, the material properties of the AM material, etc. The stirring may help prevent or reduce the formation of undesirable microstructures that may otherwise form in the AM material as it cools and hardens.

FIG. 5G shows another example of a first scan path 511g, a second scan path 512g, and a combined scan path 513g. As shown in the example of FIG. 5G, the first scan path 511g may be substantially linear, whereas the combined scan path 513g, which may ultimately create the melt pool or otherwise melts or sinters the previously unfused AM material may have the complex looped path shown in FIG. 5G with respect to the first scan path 511g to have a stirring (e.g. stir-welding) effect as the AM material solidifies. The complex looped combined path can be created by the second path 512g travelling in a complex, overlapping loop, as seen in the figure. The complex, overlapping looped path may be used, for example, to stir (e.g., stir-weld) the melted AM material in a complex motion as the laser path quickly loops in a complex, overlapping motion throughout the path. The stirring may help prevent or reduce the formation of undesirable microstructures that may otherwise form in the AM material as it cools and hardens.

FIG. 5H shows another example of a first scan path 511h, a second scan path 512h, and a combined scan path 513h. As shown in the example of FIG. 5H, the primary scan path 511h may be substantially linear, whereas the secondary scan path 513h, which may ultimately create the melt pool or otherwise melts or sinters the previously unfused AM material may have the square or rectangular wave-shaped path shown in FIG. 5H with respect to the first scan path 511h. The square or rectangular wave-shaped combined path can be created by the second path 512h travelling up and down between point G and H, as seen in the figure. In particular, second path 512h can travel between points G and H very quickly, then pause at points C and D for a period of time. The square or rectangular wave-shaped path may be used, for example, to emulate a wider melt pool than possible using an MOS alone while creating a unique pattern of differently exposed portions of AM material, which may be suitable for creating support structures for a build piece that are more easily removable.

For the purpose of clarity, the example scan paths in FIGS. 5A-H are illustrated without representing a melt pool, which can be formed by the laser beam in various AM processes, such as PBF printing. For example, FIG. 6A illustrate two melt pools 615a and 615b created by laser beam profile 617a and 617b, respectively, which may be formed by the same laser beam at different times during scanning in directions indicated by the arrows in the figure. For example, melt pool 615a may have been created as laser beam profile 617a was scanning downward (as seen in the figure), and melt pool 615b may have been created as laser beam profile 617b was subsequently scanning upward (as seen in the figure). FIG. 6A illustrates that previous and subsequent melt pools may overlap, which can allow a contiguous buildpiece to be formed, for example.

FIG. 6B illustrates an example melt pool 621 traveling along the zig-zag combined path 513a shown in FIG. 5A. FIG. 6B shows how a melt pool, such as travelling melt pool 621, can be made to overlap using certain combined paths, such as shown in FIG. 5A, to create a “widened” melt pool along the direction of a first path, such as first scan path 511a.

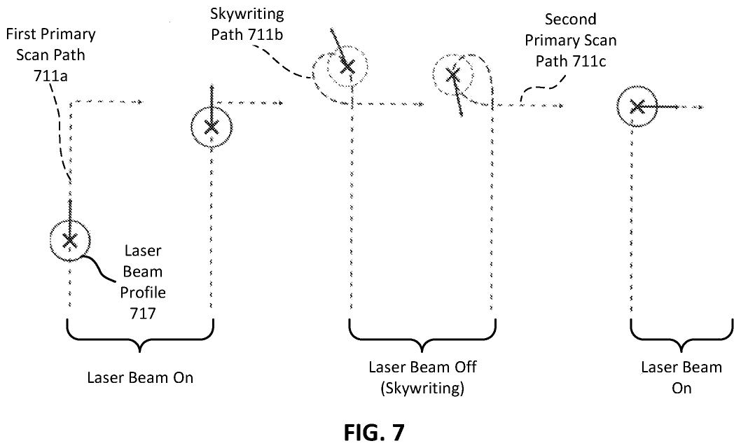

In addition to the advantages described above, aspects of this disclosure may further improve efficiency of laser use during the build process. When forming a buildpiece using an AM process with scanning/build strategies that include sharp changes in scanning direction, such as a sharp 90-degree turn, the laser beam must be turned off or de-focused when it reaches the sharp direction change while a movable-optic scanner (e.g., galvanometer) executes a looping path to gradually change the direction. Once the looping path reconnects with the desired path, the laser beam is turned back on and/or re-focused and continues in the new direction. This procedure is known as skywriting. FIG. 7 shows an example 90-degree turn or scan path with a first primary scan path 711a and a second primary scan path 711c. If the build profile of the build piece requires melting or sintering of the build material in an area of the laser beam profile 717 along the first primary scan path 711a and second primary scan path 711c, typically, when using just a movable-optic scanner (e.g., a galvanometer) to control the laser path, the inertia of the movable mirror/lens (i.e., the tendency of the mirror/lens to continue scanning in a straight line and resist changing direction) requires a looped path or “skywriting” path to be implemented. The skywriting path 711b may be a curved path or looped path during which the laser is turned-off or defocused. Then, after the beam path loops back-around to align with the second primary scan path 711c, the laser is turned back on or re-focused to again form a melt-pool or sinter the build material to continue formation of the build-piece. The time the laser beam must be turned off or de-focused during the scan due to skywriting is wasted time, which can be an inefficiency of AM systems using movable-optic scanners. Using various embodiments in accordance with the present disclosure, skywriting may be reduced or eliminated, thereby increasing efficiency by, for example, 2%-15%. When implementing aspects of this disclosure, namely the use of both a movable-optic scanner and at least one SSS, the movable-optic scanner (e.g., MOS 105 in FIGS. 1A-1D, MOS 205 of FIG. 2, galvanometer(s) 305 of FIGS. 3A and 3B, MOS 405 of FIG. 4) and/or the SSS (e.g., solid state scanner(s) 104 of FIGS. 1A-1D, solid state scanner(s) 204 of FIG. 2, solid state scanner(s) 304a and/or 304b of FIGS. 3A and 3B, and/or solid state scanner(s) 404 of FIG. 4) may be controlled compensate for the effects of inertia of the movable-optic scanner for improved efficiency. As noted above, by reducing or eliminating the wasted time that the laser is turned off or de-focused for skywriting, the efficiency of some AM systems may be improved.

FIG. 8 shows one example of a method of forming a 90-degree laser beam path implementing aspects described herein. In particular, FIG. 8 shows an example scanning of a laser beam, represented by laser beam profile 818, at five consecutive points in time (from left to right). The top portion of the figure illustrates the first scan path superimposed with the combined scan path at each point in time, and the bottom portion of the figure illustrates the second scan path by showing the position of the laser beam at each point in time and showing a direction of second scan path 817 when the position is changing. By controlling both a movable-optic scanner and SSS, the position of the laser beam profile 818 can be controlled to be anywhere within an SSS scanning zone 821 (represented by the dashed boxes in the figure) that coincides with and may generally be centered over the galvanometer scan location 812 (represented by an “X” in the figure). Since the SSS can operate independently from the movable-optic scanner, the SSS can cause the laser beam to scan on a desired laser beam path 813 (i.e., including the 90-degree turn) while the MOS is executing a skywriting scan path 811. In this way, for example, the laser beam can remain turned on throughout the entire scan while achieving a 90-degree turn that is not possible using an MOS alone. It should be noted that although in the examples described below, a perfect 90-degree turn is shown, the turn may actually still have a small but negligible curvature because the SSS, while extremely fast, is not infinitely fast. For example, implementation of the SSS, the curve at a 90-degree turn may be significantly less that (e.g., one or two orders of magnitude or more) than a curve that would result if just using a movable-optic scanner. The laser beam profile can be quickly controlled by an SSS to be located anywhere within the SSS scanning zone 821. Further since an SSS can quickly control the location of the laser beam profile 818 without any effects of inertia (or with minimal effects of inertia when compared to a movable-optic scanner), the laser beam profile 818 can be precisely placed within the SSS scanning zone 821. So for example, when desired laser beam path 813 requires a sharp curve, (which would conventionally require the laser beam switched of during a skywriting path maneuver of the movable-optic scanner), the first scan path 811, which includes a skywriting scan path 811, can be shifted and the SSS controlled to direct the laser beam profile 818 along a combined path that more-closely follows the desired laser beam path 813 without having to turn-off or de-focus the laser beam. As mentioned above, the top half view of FIG. 8 shows the scanning location of the laser beam profile 818. The bottom half of FIG. 8 shows a simplified view of the laser beam scanning profile in the top half view above, i.e., only showing the galvanometer scanning location (the “X”), and the laser beam position within the SSS scanning zone 821 boundary and the direction of second scan path 817 (if the SSS is moving the position) to show more clearly how the SSS may move the laser beam profile 818 within the SSS scanning zone 821 boundary, including the x,y coordinates of the laser beam profile 818 (which ranges from approximately −1.0 to +1.0 in the x and y directions). In FIG. 8, the direction the movable-optic scanner is pointed is the galvanometer scan location 812 (which is, for example, the location the laser profile 818 would be in if the SSS were not implemented into the AM system), is represented by the “X”. In the previous example of FIG. 7, the movable-optic scanner is always pointed in the same direction as the laser beam profile 717 because only the movable-optic scanner controls the location of the laser beam profile 717, which is why the laser beam profile 717 is always centered on the “X”. In contrast, in the example implementation of aspects of this disclosure shown in FIG. 8, the laser beam profile 818 is not necessarily centered on the “X” and is, within the bounds of SSS scanning zone 821, independent of the galvanometer scan location 812 denoted by the “X,” because the SSS can move the beam “off center” of the galvanometer scan location 812 within the SSS scanning zone 821.

As shown at the left side of FIG. 8, as the laser scanner is scanning the beam to approach the 90-degree turn, the SSS positions the beam profile 818 at x=−0.9, y=+0.2 within the SSS scanning zone 821, in preparation for the turn. In this position, the SSS may keep the position stationary within the SSS scanning zone 821, therefore the direction of combined scan path 815 and the direction of first scan path 811 are the same. However, although the laser beam profile 818 is on the desired beam path 813, the position of the galvanometer scan location 812 is distanced from the desired beam path 813 within bounds of the SSS scanning zone 821. At this time, the laser beam profile 818 and the galvanometer scan location 812 are moving parallel to one another (i.e., upwards) because the SSS is not changing the position of the laser beam profile 818 within the SSS scanning zone 821. When the laser beam profile 818 reaches the 90-degree turn (shown second-from-left in FIG. 8), the movable-optic scanner begins executing a skywriting scan path 811 portion of the first scan path, and the SSS immediately begins moving the laser beam profile 818 to the right and downwards within the SSS scanning zone 821 as shown by the direction of second scan path 817 arrow (note, at this exact moment, the position of the laser beam profile 818 within the SSS scanning zone 821 is still x=−0.9, y=+0.2, but is now changing in the direction of second scan path 817). This change in position by the SSS allows the combined path to continue along the desired laser beam path 813 while the MOS executes the skywriting maneuver. For example, it is noted that as the SSS begins changing the position of the laser beam profile 818 in the SSS scanning zone 821, and the direction of first scan path 811 of the galvanometer is continuing upwards to execute the skywriting maneuver, the direction combined scan path 815 (and thus the direction of the laser beam profile 818) has abruptly changed to move directly to the right along the desired laser beam path 813. As the first scan path continues along the skywriting scan path 811 (shown in the middle of FIG. 8), the SSS keeps the laser beam profile 818 moving to the right along the desired laser beam path 813 by moving the laser beam profile 818 within the SSS scanning zone 821 (now at position x=−0.2, y=−0.7). Thus, the laser beam can remain turned on or focused and continue along the desired laser beam path 813, while the “X” indicating the galvanometer scan location 812 progresses along the skywriting path 811. As shown second-from-right in FIG. 8, the movable-optic scanner (e.g., galvanometer) continues skywriting, and the SSS moves or otherwise adjusts the beam profile 818 along the desired laser beam path 813, now at x=+0.7, y=−0.4. Finally, as shown at the right of FIG. 8, the movable-optic scanner (e.g., galvanometer) completes skywriting and may now be moving parallel to or along the desired laser beam path 813, and the second scan path of the SSS has ended within the SSS scanning zone 821 at x=+0.9, y=+0.1.

In the example described above with respect to FIG. 8, it is noted that the x-position of the laser beam profile 818 within the SSS scanning zone 821 scanned from −0.9 to +0.9, with the SSS scanning over almost the entire x-direction of SSS scanning zone 821 to keep the laser beam profile 818 scanning along the desired laser beam path 813 and at the desired beam speed. For subsequent turns that may require skywriting, the movable-optic scanner and the SSS can be controlled simultaneously to move the laser beam profile 818 into the best position in the SSS scanning zone 821 while continuing to scan the laser beam profile 818 at the correct scanning speed along a desired beam path. This repositioning of the beam in the SSS scanning zone 821 may involve the movable-optic scanner increasing or decreasing speed and/or adjusting the galvanometer scan location 812 to allow the SSS to position the at the desired position within the SSS scanning zone 821, all the while keeping the laser beam profile 818 at the correct speed along a desired beam path. In this way, for example, the laser beam profile 818 can be re-set or re-positioned in the SSS scanning zone 821 to allow for additional maneuvers during scanning while avoiding turning-off or defocusing of the laser.

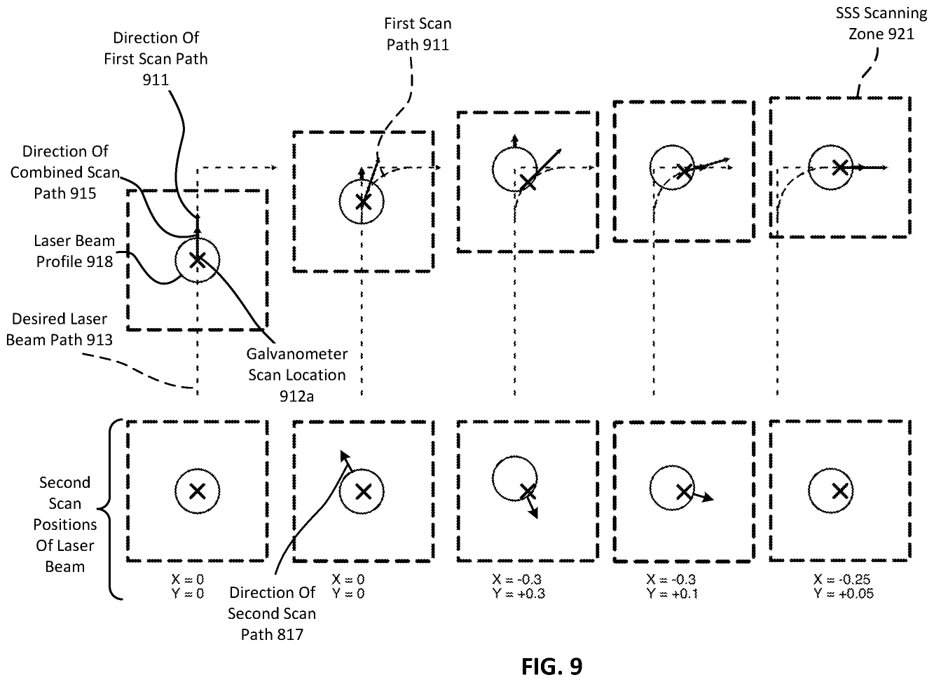

Another example of improved efficiency 90-degree turn during an AM build implementing aspects of this disclosure is shown in FIG. 9. As described above, when forming a buildpiece using an AM process with scanning/build strategies that include sharp changes in scanning direction, such as a sharp 90-degree turn, the movable-optic scanner (e.g., galvanometer) may need to follow a curved path to gradually change direction to control or compensate for the inertia of the mirror/deflector (i.e., the tendency of the mirror to continue scanning in a straight line and resist changing direction). In contrast to the example of FIG. 8, in which the first scan path of the MOS emulates a “skywriting” path, e.g., looping path, FIG. 9 shows an example of a “corner-cutting” path taken by the first scan path. In other words, instead of the MOS executing a curved first path after the laser beam has reached the sharp turn, the example of FIG. 9 shows the MOS can execute a curved first path before the laser beam reaches the sharp turn in the desired path, while the SSS can allow the laser beam to continue along the desired path, make the sharp turn, and “catch up” with the first path of the MOS. By implementing aspects of the current disclosure, namely the use of both a movable-optic scanner and at least one SSS, the movable-optic scanner (e.g., MOS 105 in FIGS. 1A-1D, the MOS 205 of FIG. 2, the galvanometer(s) 305 of FIGS. 3A and 3B, and the MOS 405 of FIG. 4) and the SSS (e.g., solid state scanner(s) 104 of FIGS. 1A-1D, solid state scanner(s) 204 of FIG. 2, solid state scanner(s) 304a and/or 304b of FIGS. 3A and 3B, and/or solid state scanner(s) 404 of FIG. 4) can be controlled to create a combined path that follows the desired laser beam path 913. As noted above, by eliminating the wasted time that the laser is turned off or de-focused for skywriting, the efficiency may be improved.

FIG. 9 shows one example of a method of forming a 90-degree combined path for, e.g., melting or sintering implementing aspects described herein. By controlling both a movable-optic scanner and SSS, the position of the laser beam profile 918 can be controlled to be anywhere within the SSS scanning zone 921 that follows and may generally be centered over the galvanometer scan location 912. SSS can create a second scan path that can be combined with the first scan path of the movable-optic scanner. The laser beam profile can be quickly controlled to follow a combined path that is anywhere within the SSS scanning zone 921. Further since an SSS can quickly control the location of the laser beam profile 911 without any effects of inertia (or with minimal effects of inertia when compared to a movable-optic scanner), the laser beam profile 918 can be precisely placed within the SSS scanning zone 921. So for example, when a desired laser beam path 913 requires a sharp curve, the movable-optic scanner can be allowed to follow a more gently-curved portion of the first scan path 911, and the SSS can create a second scan path to direct the laser beam profile 918 to follow or more closely follow the desired laser beam path 913. It is noted that while in the example shown in FIG. 9 a 90-degree desired laser beam path 913 is shown, the actual beam path, i.e., the combined scan path, may also have a curve that is significantly smaller than (i.e., one or two orders of magnitude) than the curved portion of the first scan path 911. In a similar way of illustration as FIG. 8, FIG. 9 shows an example scanning of a laser beam, represented by laser beam profile 918, at five consecutive points in time (from left to right). The top portion of the figure illustrates the first scan path superimposed with the combined scan path at each point in time, and the bottom portion of the figure illustrates the second scan path by showing the position of the laser beam at each point in time and showing a direction of second scan path 917 when the position is changing. In other words, the top half view of FIG. 9 shows the scanning location of the laser beam profile 918, and the bottom half of FIG. 9 shows a simplified view of the laser beam scanning profile in the top half view above, i.e., only showing the galvanometer scanner direction (the “X”), and the laser beam position within the SSS scanning zone 912 boundary to show more clearly how the SSS may move the laser beam profile 918 within the SSS scanning zone 912 boundary (as represented by direction of second scan 917), including the x,y coordinates of the laser beam profile 918. As shown in FIG. 9, an otherwise curved portion 911 of the first scan path can be corrected by the SSS, so that the laser beam profile 918 instead follows the desired laser beam path 913, thus allowing quick-change of direction (e.g., such as the 90-degree turn in FIG. 9) without having to skywrite.

As shown at the left side of FIG. 9, as the laser scanner is scanning the beam to approach the 90-degree turn, the SSS positions the beam profile 918 at x=0, y=0 within the SSS scanning zone 921, in preparation for the turn. In this position, the SSS may keep the position stationary within the SSS scanning zone 921, therefore the direction of combined scan path 915 and the direction of first scan path 911 are the same. As shown second-from-left in FIG. 9, before the laser beam profile 918 reaches the 90-degree turn, the first scan path of the movable-optic scanner begins curving to “cut the corner” of the 90-degree turn, and the SSS immediately begins moving the laser beam profile 918 to the left and upwards within the SSS scanning zone 921 as shown by the direction of second scan path 917 arrow (note, at this exact moment, the position of the laser beam profile 918 within the SSS scanning zone 921 is still x=0, y=0, but is now changing in the direction of second scan path 917). This change in position by the SSS allows the combined path to continue along the desired laser beam path 913 while the MOS cuts the corner of the 90-degree turn. For example, it is noted that as the SSS begins changing the position of the laser beam profile 918 in the SSS scanning zone 921, and the direction of combined scan path 915 is continuing upwards along the desired laser beam path 913, the direction of first scan path 911 of the galvanometer has changed to follow the curve to cut the corner. As the first scan path continues along the curved path (shown in the middle of FIG. 9), the laser beam profile 918 reaches the 90-degree turn. At this point, the laser beam profile is at position x=−0.3, y=+0.3 within the SSS scanning zone 921, and the SSS abruptly changes the direction of second scan path 917 to cause the laser beam profile 918 to move to the right along the desired laser beam path 913. Thus, the laser beam can remain turned on or focused and continue along the desired laser beam path 913, while the “X” indicating the galvanometer scan location 912 progresses along the corner-cutting curved path. As shown second-from-right in FIG. 9, the movable-optic scanner (e.g., galvanometer) continues its corner-cutting path, and the SSS moves or otherwise adjusts the beam profile 918 along the desired laser beam path 913, now at x=−0.3, y=+0.1. Finally, as shown at the right of FIG. 9, the movable-optic scanner (e.g., galvanometer) completes the corner-cutting and may now be moving parallel to or along the desired laser beam path 913, and the second scan path of the SSS has ended within the SSS scanning zone 921 at x=−0.25, y=+0.05.

Similar to described above in the example of FIG. 8, for subsequent turns that may require corner-cutting, the movable-optic scanner and the SSS can be controlled simultaneously to move the laser beam profile 918 into the best position in the SSS scanning zone 921 while continuing to scan the laser beam profile 918 at the correct scanning speed along a desired beam path. This repositioning of the beam in the SSS scanning zone 921 may involve the movable-optic scanner increasing or decreasing speed and/or adjusting the galvanometer scan location 912 to allow the SSS to position the at the desired position within the SSS scanning zone 921, all the while keeping the laser beam profile 918 at the correct speed along a desired beam path. In this way, for example, the laser beam profile 918 can be re-set or re-positioned in the SSS scanning zone 921 to allow for additional maneuvers during scanning while avoiding turning-off or defocusing of the laser.

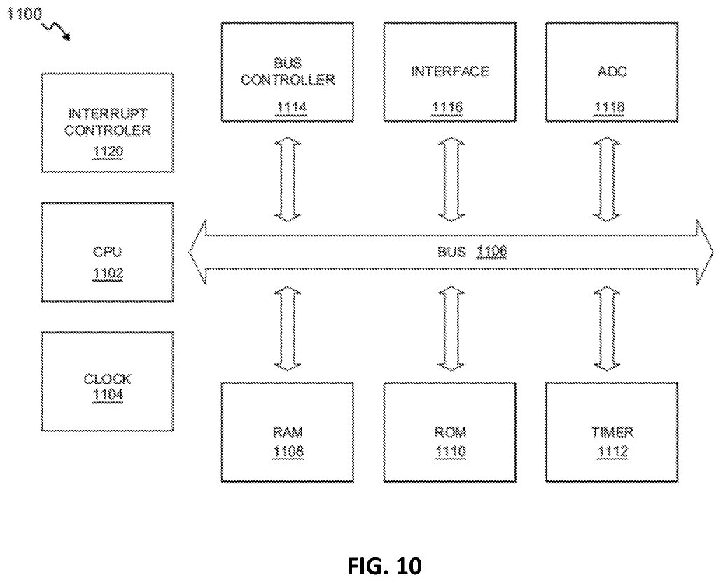

It is noted that the aforementioned operations are provided as examples. While some specific examples are given, one having ordinary skill in the art would understand that additional possibilities of automated, semi-automated, or manual control of the systems and devices disclosed. In some implementations, as part of or incorporating various features and methods described herein, one or more microcontrollers may be implemented for controlling any one or combination of the operations described herein (e.g., the operations of the AM system and/or movable-optic scanner(s) and solid-state scanner(s) and apparatuses described herein). Various components of an example of such a controller 1100 are shown in representative block diagram form in FIG. 10. In FIG. 10, the controller 1100 includes a CPU 1102, clock 1104, RAM 1108, ROM 1110, a timer 1112, a BUS controller 1114, an interface 1116, and an analog-to-digital converter (ADC) 1118 interconnected via a BUS 1106. The CPU 1102 may be implemented as one or more single core or multi-core processors, and receive signals from an interrupt controller 1120 and a clock 1104. The clock 1104 may set the operating frequency of the entire microcontroller 1100 and may include one or more crystal oscillators having predetermined frequencies. Alternatively, the clock 1104 may receive an external clock signal. The interrupt controller 1120 may also send interrupt signals to the CPU, to suspend CPU operations. The interrupt controller 1120 may transmit an interrupt signal to the CPU when an event requires immediate CPU attention.

The RAM 1108 may include one or more Static Random Access Memory (SRAM), Dynamic Random Access Memory (DRAM), Synchronous Dynamic Random Access Memory (SDRAM), Double Data-Rate Random Access Memory (DDR SDRAM), or other suitable volatile memory. The Read-only Memory (ROM) 1110 may include one or more Programmable Read-only Memory (PROM), Erasable Programmable Read-only Memory (EPROM), Electronically Erasable Programmable Read-only memory (EEPROM), flash memory, or other types of non-volatile memory.

The timer 1112 may keep time and/or calculate the amount of time between events occurring within the controller 1100, count the number of events, and/or generate baud rate for communication transfer. The BUS controller 1114 may prioritize BUS usage within the controller 1100. The ADC 1118 may allow the controller 1100 to send out pulses to signal other devices.

The interface 1116 may comprise an input/output device that allows the controller 1100 to exchange information with other devices. In some implementations, the interface 1116 may include one or more of a parallel port, a serial port, or other computer interfaces.

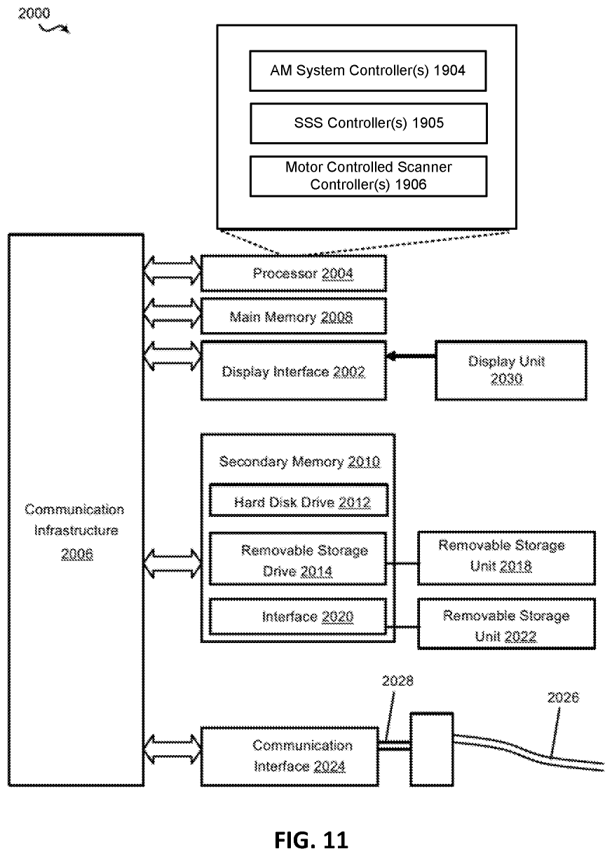

In addition, aspects of the present disclosures may be implemented using hardware, software, or a combination thereof and may be implemented in one or more computer systems or other processing systems. In an aspect of the present disclosures, features are directed toward one or more computer systems capable of carrying out the functionality described herein. An example of such the computer system 2000 is shown in FIG. 11.

The computer system 2000 may include one or more processors, such as processor 2004. The processor 2004 may be connected to a communication infrastructure 2006 (e.g., a communications bus, cross-over bar, or network). Various software aspects are described in terms of this example computer system. After reading this description, it will become apparent to a person skilled in the relevant art(s) how to implement aspects of the disclosures using other computer systems and/or architectures.

The computer system 2000 may include a display interface 2002 that forwards graphics, text, and other data from the communication infrastructure 2006 (or from a frame buffer not shown) for display on a display unit 2030, which may be analogous with the display interface 102. Computer system 2000 also includes a main memory 2008, preferably random access memory (RAM), and may also include a secondary memory 2010. The secondary memory 2010 may include, for example, a hard disk drive 2012, and/or a removable storage drive 2014, representing a floppy disk drive, a magnetic tape drive, an optical disk drive, a universal serial bus (USB) flash drive, etc. The removable storage drive 2014 reads from and/or writes to a removable storage unit 2018 in a well-known manner. Removable storage unit 2018 represents a floppy disk, magnetic tape, optical disk, USB flash drive etc., which is read by and written to removable storage drive 2014. As will be appreciated, the removable storage unit 2018 includes a computer usable storage medium having stored therein computer software and/or data.

Alternative aspects of the present disclosure may include secondary memory 2010 and may include other similar devices for allowing computer programs or other instructions to be loaded into computer system 2000. Such devices may include, for example, a removable storage unit 2022 and an interface 2020. Examples of such may include a program cartridge and cartridge interface (such as that found in video game devices), a removable memory chip (such as an erasable programmable read only memory (EPROM), or programmable read only memory (PROM)) and associated socket, and other removable storage units 2022 and interfaces 2020, which allow software and data to be transferred from the removable storage unit 2022 to computer system 2000.

Computer system 2000 may also include a communications interface 2024. Communications interface 2024 allows software and data to be transferred between computer system 2000 and external devices. Examples of communications interface 2024 may include a modem, a network interface (such as an Ethernet card), a communications port, a Personal Computer Memory Card International Association (PCMCIA) slot and card, etc. Software and data transferred via communications interface 2024 are in the form of signals 2028, which may be electronic, electromagnetic, optical or other signals capable of being received by communications interface 2024. These signals 2028 are provided to communications interface 2024 via a communications path (e.g., channel) 2026. This path 2026 carries signals 2028 and may be implemented using wire or cable, fiber optics, a telephone line, a cellular link, an RF link and/or other communications channels. In this document, the terms “computer program medium” and “computer usable medium” are used to refer generally to media such as a removable storage drive 2018, a hard disk installed in hard disk drive 2012, and signals 2028. These computer program products provide software to the computer system 2000. Aspects of the present disclosures are directed to such computer program products.

Computer programs (also referred to as computer control logic) are stored in main memory 2008 and/or secondary memory 2010. Computer programs may also be received via communications interface 2024. Such computer programs, when executed, enable the computer system 2000 to perform the features in accordance with aspects of the present disclosures, as discussed herein. In particular, the computer programs, when executed, enable the processor 2004 to perform the features in accordance with aspects of the present disclosures. Accordingly, such computer programs represent controllers of the computer system 2000.

In an aspect of the present disclosures where the method is implemented using software, the software may be stored in a computer program product and loaded into computer system 2000 using removable storage drive 2014, hard drive 2012, or communications interface 2020. The control logic (software), when executed by the processor 2004, causes the processor 2004 to perform the functions described herein. In some examples, the computer system 2000 may include one or more AM controller(s) 1904, e.g., for controlling any one or combination of the AM systems described above with respect to FIGS. 1A-9) and/or SSS controller(s) 1905 and/or movable-optic scanner controller(s) 1906 for controlling any one or combination of the SSS(s) and movable-optic scanner(s), which may for example control any one or combination of the features described above with respect to FIGS. 1A-9. In another aspect of the present disclosures, the system is implemented primarily in hardware using, for example, hardware components, such as application specific integrated circuits (ASICs). Implementation of the hardware state machine so as to perform the functions described herein will be apparent to persons skilled in the relevant art(s).

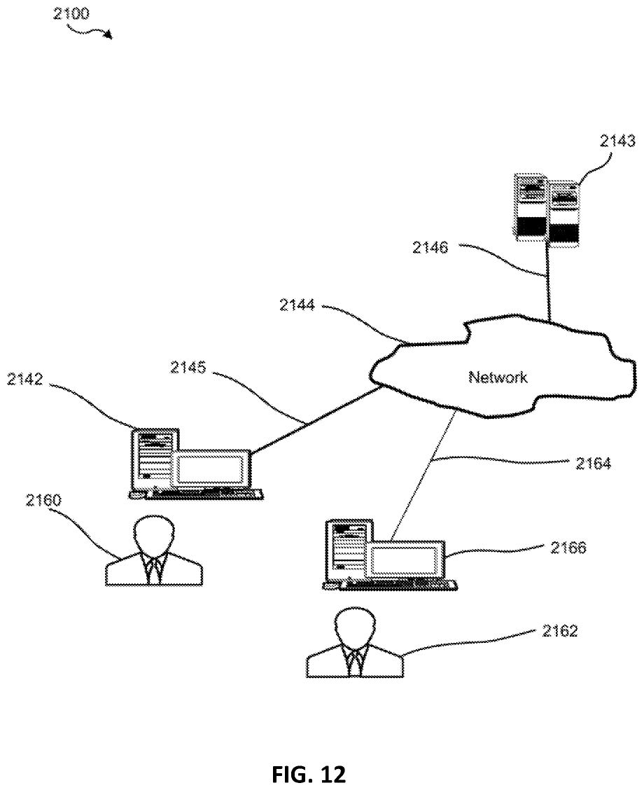

FIG. 12 is a block diagram of various example communication system components usable in accordance with an aspect of the present disclosure. The communication system 2100 includes one or more accessors 2160, 2162 (which may for example comprise any of the aforementioned systems and features) and one or more terminals 2142, 2166. In one aspect, data for use in accordance with aspects of the present disclosure is, for example, input and/or accessed by accessors 2160, 2162 via terminals 2142, 2166, such as personal computers (PCs), minicomputers, mainframe computers, microcomputers, telephonic devices, or wireless devices, such as personal digital assistants (“PDAs”) or a hand-held wireless devices coupled to a server 2143, such as a PC, minicomputer, mainframe computer, microcomputer, or other device having a processor and a repository for data and/or connection to a repository for data, via, for example, a network 2144, such as the Internet or an intranet, and couplings 2145, 2146, 2164. The couplings 2145, 2146, 2164 include, for example, wired, wireless, or fiberoptic links. In another example variation, the method and system in accordance with aspects of the present disclosure operate in a stand-alone environment, such as on a single terminal.

Additional aspects of the disclosure are described in the following clauses:

Clause 1. An additive manufacturing (AM) apparatus comprising: a laser apparatus configured to provide a laser beam; a laser scanner comprising: a movable-optic scanner including one or more optics, the movable-optic scanner configured move the one or more optics to scan the laser beam along a first path, and a solid-state scanner configured to scan the laser beam along a second path; and a controller configured to control the laser scanner to operate the movable-optic scanner and the solid-state scanner to combine the first path and the second path to obtain a combined path during an AM process.

Clause 2. The AM apparatus of clause 1, further comprising: a depositor configured to deposit a material, wherein the controller is further configured to operate the laser scanner to apply the laser beam to the deposited material along the combined path.

Clause 3. The AM apparatus of any of the preceding clauses, wherein the material comprises a powder material, and the AM apparatus further comprises: a leveler configured to level the powder material to obtain a powder layer, wherein the controller is further configured operate the laser scanner to apply the laser beam to the powder layer along the combined path.

Clause 4. The AM apparatus of any of the preceding clauses, wherein the material comprises a powder material, the depositor is further configured to deposit the powder material to an area of a build piece, and the controller is further configured operate the laser scanner to apply the laser beam to the area of the build piece along the combined path.

Clause 5. The AM apparatus of any of the preceding clauses, wherein the material comprises a wire material, the depositor is further configured to deposit the wire material to an area of a build piece, and the controller is further configured operate the laser scanner to apply the laser beam to the area of the build piece along the combined path.

Clause 6. The AM apparatus of any of the preceding clauses, wherein the solid-state scanner comprises an acousto-optic device.

Clause 7. The AM apparatus of any of the preceding clauses, wherein the solid-state scanner comprises an electro-optic device.

Clause 8. The AM apparatus of any of the preceding clauses, wherein the movable-optic scanner comprises galvanometer.

Clause 9. The AM apparatus of any of the preceding clauses, wherein the solid-state scanner comprises a first solid-state scanner configured to scan the laser beam along a first dimension.

Clause 10. The AM apparatus of any of the preceding clauses, wherein the solid-state scanner further comprises a second solid-state scanner configured to scan the laser beam along a second dimension different that the first dimension.

Clause 11. The AM apparatus of any of the preceding clauses, wherein the first dimension and the second dimensions are orthogonal.

Clause 12. The AM apparatus of any of the preceding clauses, wherein the movable-optic scanner is configured to control an x-position and a y-position of the laser beam, and the solid-state scanner is configured to control at least a secondary x-position or a secondary y-position of the laser beam.

Clause 13. The AM apparatus of any of the preceding clauses, wherein the solid-state scanner controls the at least the secondary x-position or secondary y-position at a significantly higher speed than the movable-optic scanner controls an x-position and a y-position of the laser beam.

Clause 14. The AM apparatus of any of the preceding clauses, wherein second path includes a non-linear path, and first path includes a linear path.

Clause 15. The AM apparatus of any of the preceding clauses, wherein in the second path includes at least a looped path, zig-zag path, curved path, circular path, forward-backward path, elliptical path, triangular path, or a square path.

Clause 16. The AM apparatus of any of the preceding clauses, wherein the solid-state scanner is configured to direct the laser beam along a first line and a second line that intersects the first line as the movable-optic scanner directs the laser beam along a curved path.

Clause 17. The AM apparatus of any of the preceding clauses, wherein the first line and the second line are substantially linear.

Clause 18. The AM apparatus of any of the preceding clauses, wherein the first path comprises a first curve having a first radius of curvature during a period of time, the combined path comprises a second curve having a second radius of curvature during the period of time, wherein the first radius of curvature is greater than the second radius of curvature.

Clause 19. The AM apparatus of any of the preceding clauses, wherein the first radius of curvature is at least an order of magnitude greater than the second radius of curvature.

Clause 20. The AM apparatus of any of the preceding clauses, wherein the first radius of curvature is at least two orders of magnitude greater than the second radius of curvature.

Clause 21. An additive manufacturing (AM) method for scanning a laser beam with a movable-optic laser scanner and a solid-state laser scanner to form an AM build, the method further comprising: scanning an x-position and a y-position of the laser beam with the movable-optic laser scanner while scanning at least one of a combined x-position or a combined y-position of the laser beam with the solid-state laser scanner.

Clause 22. The AM method of clause 21, further comprising; applying a layer of powder material in a build area; leveling the layer of powder; and scanning the x-position, y-position, and said at least the combined x-position or combined y-position to apply laser beam to at least a portion of the leveled powder.

Clause 23. The AM method of any of the preceding clauses, wherein scanning said at least the combined x-position or the combined y-position of the laser beam with a solid-state device comprises controlling at least one of an acousto-optic device or an electro-optic device.

Clause 24. The AM method of any of the preceding clauses, wherein scanning the x-position and y-position of the laser beam with a movable-optic laser scanner comprises controlling a galvanometer.

Clause 25. The AM method of any of the preceding clauses, further comprising: controlling a first solid state scanning device and a second solid-state scanning device to scan both the combined x-position and combined y-position of the laser beam.

Clause 26. The AM method of any of the preceding clauses, wherein the at least said combined x-position and combined y-position is controlled at a higher frequency than the x-position and the y-position.

Clause 27. An additive manufacturing (AM) method for forming an AM build comprising: applying a layer of powder material in a build area; leveling the layer of powder; and applying laser beam to at least one portion of the leveled layer of power by controlling a path of the laser beam with a first scanning device and a second scanning device, wherein the second scanning device is a solid-state device.

Clause 28. The AM method of clause 27, wherein the first scanning device is a galvanometer.

Clause 29. The AM method of any of the preceding clauses, wherein the second scanning device is at least one of an acousto-optic device or an electro-optic device.

Clause 30. The AM method of any of the preceding clauses, further comprising scanning the laser beam along a linear path with the first scanning device while scanning the laser beam along a non-linear path with the second scanning device.

Clause 31. The AM method of any of the preceding clauses, wherein the non-linear path comprises at least a looped path, a zig-zag path, a curved path, a circular path, a forward-backward path, an elliptical path, a triangular path, or a square path with the second scanning device.

Clause 32. The AM method of any of the preceding clauses, further comprising scanning the laser beam along a first path and a second path that intersects the first path with the second scanning device while directing the laser beam along a curved path with the first scanning device.

Clause 33. The AM method of any of the preceding clauses, wherein the first path and the second path are substantially linear.

The previous description is provided to enable any person skilled in the art to practice the various aspects described herein. Various modifications to these exemplary embodiments presented throughout this disclosure will be readily apparent to those skilled in the art, and the concepts disclosed herein may be applied to other support structures and systems and methods for removal of support structures. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. An additive manufacturing (AM) apparatus comprising:
a laser apparatus configured to provide a laser beam;
a laser scanner comprising:
a movable-optic scanner including one or more optics, the movable-optic scanner configured move the one or more optics to scan the laser beam along a first path, and
a solid-state scanner configured to scan the laser beam along a second path; and
a controller configured to control the laser scanner to operate the movable-optic scanner and the solid-state scanner to combine the first path and the second path to obtain a combined path during an AM process.

2. The AM apparatus of claim 1, further comprising:
a depositor configured to deposit a material, wherein the controller is further configured to operate the laser scanner to apply the laser beam to the deposited material along the combined path.

3. The AM apparatus of claim 2, wherein the material comprises a powder material, and the AM apparatus further comprises:
a leveler configured to level the powder material to obtain a powder layer, wherein the controller is further configured operate the laser scanner to apply the laser beam to the powder layer along the combined path.

4. The AM apparatus of claim 2, wherein the material comprises a powder material, the depositor is further configured to deposit the powder material to an area of a build piece, and the controller is further configured operate the laser scanner to apply the laser beam to the area of the build piece along the combined path.

5. The AM apparatus of claim 2, wherein the material comprises a wire material, the depositor is further configured to deposit the wire material to an area of a build piece, and the controller is further configured operate the laser scanner to apply the laser beam to the area of the build piece along the combined path.

6. The AM apparatus of claim 1, wherein the solid-state scanner comprises an acousto-optic device.

7. The AM apparatus of claim 1, wherein the solid-state scanner comprises an electro-optic device.

8. The AM apparatus of claim 1, wherein the movable-optic scanner comprises galvanometer.

9. The AM apparatus of claim 1, wherein the solid-state scanner comprises a first solid-state scanner configured to scan the laser beam along a first dimension.

10. The AM apparatus of claim 9, wherein the solid-state scanner further comprises a second solid-state scanner configured to scan the laser beam along a second dimension different that the first dimension.

11. The AM apparatus of claim 10, wherein the first dimension and the second dimensions are orthogonal.

12. The AM apparatus of claim 1, wherein the movable-optic scanner is configured to control an x-position and a y-position of the laser beam and the solid-state scanner is configured to control at least a secondary x-position or a secondary y-position of the laser beam.

13. The AM apparatus of claim 12, wherein the solid-state scanner controls the at least the secondary x-position or secondary y-position at a significantly higher speed than the movable-optic scanner controls an x-position and a y-position of the laser beam.

14. The AM apparatus of claim 1, wherein second path includes a non-linear path, and first path includes a linear path.

15. The AM apparatus of claim 1, wherein in the second path includes at least a looped path, zig-zag path, curved path, circular path, forward-backward path, elliptical path, triangular path, or a square path.

16. The AM apparatus of claim 1, wherein the solid-state scanner is configured to direct the laser beam along a first line and a second line that intersects the first line as the movable-optic scanner directs the laser beam along a curved path.

17. The AM apparatus of claim 16, wherein the first line and the second line are substantially linear.

18. The AM apparatus of claim 1, wherein the first path comprises a first curve having a first radius of curvature during a period of time, the combined path comprises a second curve having a second radius of curvature during the period of time, wherein the first radius of curvature is greater than the second radius of curvature.

19. The AM apparatus of claim 18, wherein the first radius of curvature is at least an order of magnitude greater than the second radius of curvature.

20. The AM apparatus of claim 18, wherein the first radius of curvature is at least two orders of magnitude greater than the second radius of curvature.

21. An additive manufacturing (AM) method for scanning a laser beam with a movable-optic laser scanner and a solid-state laser scanner to form an AM build, the method further comprising:
scanning an x-position and a y-position of the laser beam with the movable-optic laser scanner while scanning at least one of a combined x-position or a combined y-position of the laser beam with the solid-state laser scanner.

22. The AM method of claim 21, further comprising;
applying a layer of powder material in a build area;
leveling the layer of powder; and
scanning the x-position, y-position, and said at least the combined x-position or combined y-position to apply laser beam to at least a portion of the leveled powder.

23. The AM method of claim 21, wherein scanning said at least the combined x-position or the combined y-position of the laser beam with a solid-state device comprises controlling at least one of an acousto-optic device or an electro-optic device.

24. The AM method of claim 21, wherein scanning the x-position and y-position of the laser beam with a movable-optic laser scanner comprises controlling a galvanometer.

25. The AM method of claim 21, further comprising:
controlling a first solid state scanning device and a second solid-state scanning device to scan both the combined x-position and combined y-position of the laser beam.

26. The AM method of claim 21, wherein the at least said combined x-position and combined y-position is controlled at a higher frequency than the x-position and the y-position.

27. An additive manufacturing (AM) method for forming an AM build comprising:
applying a layer of powder material in a build area;
leveling the layer of powder; and
applying laser beam to at least one portion of the leveled layer of power by controlling a path of the laser beam with a first scanning device and a second scanning device, wherein the second scanning device is a solid-state device.

28. The AM method of claim 27, wherein the first scanning device is a galvanometer.

29. The AM method of claim 28, wherein the second scanning device is at least one of an acousto-optic device or an electro-optic device.

30. The AM method of claim 27, further comprising scanning the laser beam along a linear path with the first scanning device while scanning the laser beam along a non-linear path with the second scanning device.

31. The AM method of claim 30, wherein the non-linear path comprises at least a looped path, a zig-zag path, a curved path, a circular path, a forward-backward path, an elliptical path, a triangular path, or a square path with the second scanning device.

32. The AM method of claim 27, further comprising scanning the laser beam along a first path and a second path that intersects the first path with the second scanning device while directing the laser beam along a curved path with the first scanning device.

33. The AM method of claim 32, wherein the first path and the second path are substantially linear.
